(19) United States
(12) Patent Application Publication
(10) Pub. No.: US 2024/0144072 A1
(43) Pub. Date: May 2, 2024

(54) RESOURCE ACCESS REQUEST HANDLING FOR QUANTUM COMPUTING SYSTEMS

(71) Applicant: Red Hat, Inc., Raleigh, NC (US)

(72) Inventors: Leigh Griffin, Waterford (IE); Stephen Coady, Waterford (IE)

(21) Appl. No.: 17/976,951

(22) Filed: Oct. 31, 2022

(51) Int. Cl. G06N 10/80

(52) U.S. Cl. CPC G06N 10/80

(57) ABSTRACT

Information descriptive of a request to access a quantum computing resource and an intended action associated with the quantum computing resource is obtained from a quantum client device by a quantum computing system. Based at least in part on the information, a quantum computing resource access request is sent to a quantum access granting entity, wherein the quantum computing resource access request comprises information descriptive of the quantum computing resource, an intended action, and an identity of the quantum client device. A request to assign a preliminary lock to the quantum computing resource for the quantum client device is provided. Responsive to sending the quantum computing resource access request, information indicative of a decision to grant quantum computing resource access to the quantum client device is received from the quantum access granting entity.

### BACKGROUND

Quantum computing systems utilize quantum bits (“qubits”) to implement quantum computing services. A qubit in superposition can be in multiple states simultaneously. Multiple qubits in superposition can be in an exponential number of states simultaneously, which is an advantage over classical bits when solving certain problems However, qubits are relatively difficult to produce, and as such, access to quantum computing services must be carefully managed.

### SUMMARY

Aspects of the present disclosure facilitate efficient resource access request handling for quantum computing systems. More particularly, aspects of the present disclosure can receive information indicative of a request for access to a quantum computing resource from a quantum client device. In turn, a quantum computing resource access request can be sent to an access granting entity for the quantum client device alongside a request for assignment of a preliminary lock to the quantum computing resource. Information can be received that indicates a decision to grant quantum computing resource access to the quantum client device.

In one implementation, a method is provided. The method includes obtaining, by a quantum computing system from a quantum client device, information descriptive of a request to access a quantum computing resource and an intended action associated with the quantum computing resource. The method includes, based at least in part on the information, sending a quantum computing resource access request to a quantum access granting entity, wherein the quantum computing resource access request comprises information descriptive of the quantum computing resource, the intended action, and an identity of the quantum client device. The method includes providing a request to assign a preliminary lock to the quantum computing resource for the quantum client device. The method includes, responsive to sending the quantum computing resource access request, receiving, from the quantum access granting entity, information indicative of a decision to grant quantum computing resource access to the quantum client device

In another implementation, a quantum computing system is provided. The quantum computing system includes a memory, and a processor device coupled to the memory. The processor device is to obtain, from a quantum client device, information descriptive of a request to access a quantum computing resource and an intended action associated with the quantum computing resource. The processor device is further to, based at least in part on the information, send a quantum computing resource access request to a quantum access granting entity, wherein the quantum computing resource access request comprises information descriptive of the quantum computing resource, the intended action, and an identity of the quantum client device. The processor device is further to provide a request to assign a preliminary lock to the quantum computing resource for the quantum client device. The processor device is further to, responsive to sending the quantum computing resource access request, receive, from the quantum access granting entity, information indicative of a decision to grant quantum computing resource access to the quantum client device.

In another implementation, a non-transitory computer-readable storage medium is provided. The non-transitory computer-readable storage medium includes executable instructions to cause a processor device to obtain, from a quantum client device, information descriptive of a request to access a quantum computing resource and an intended action associated with the quantum computing resource. The instructions further cause the processor device to, based at least in part on the information, send a quantum computing resource access request to a quantum access granting entity, wherein the quantum computing resource access request comprises information descriptive of the quantum computing resource, the intended action, and an identity of the quantum client device. The instructions further cause the processor device to provide a request to assign a preliminary lock to the quantum computing resource for the quantum client device. The instructions further cause the processor device to, responsive to sending the quantum computing resource access request, receive, from the quantum access granting entity, information indicative of a decision to grant quantum computing resource access to the quantum client device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of a quantum computing environment at a period of time T1 in which examples may be practiced according to some implementations of the present disclosure.

FIG. 1B is a block diagram of a quantum computing environment at a second period of time T2 in which examples may be practiced according to some implementations of the present disclosure.

FIG. 2 is a flowchart of a method for access request handling for access to quantum computing resources according to some implementations of the present disclosure.

FIG. 3 is a simplified block diagram of the quantum computing environment illustrated in FIG. 1 according to some implementations of the present disclosure.

FIG. 4 is a block diagram of the quantum computing system suitable for implementing examples according to some implementations of the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Quantum computing systems utilize qubits to implement quantum computing services. As used herein, a “qubit” may refer to a unit of quantum information, or a device that stores a unit of quantum information. As a newly emerging and substantially complex area of technology, quantum computing environments generally possess a limited quantity of qubits. As such, managing access to quantum computing resources of the quantum computing environment is of paramount importance (e.g., qubits, quantum computing services implemented with qubits, quantum processes, etc.).

A quantum bit (“qubit”) in superposition can be in multiple states simultaneously. Multiple qubits in superposition can be in an exponential number of states simultaneously, which is an advantage over classical bits when solving certain problems.

Computing systems conventionally implement access controls to limit access to certain computing resources (e.g., memory, processes, services, hardware devices, etc.). In some instances, computing systems will manage access to computing resources using role-based access controls (RBAC) based on a subject, such as a task or process; an action, such as a read action, a write action, a delete action, a generate action; and a resource, such as a file, an application programming interface, a database, or the like. Namely, access granting entities will determine whether to grant or deny access to computing resources based on access policies. Access policies dictate whether an access requesting entity should be granted or denied access to computing resource based on various factors (e.g., a role assigned to the quantum access granting entity, etc.).

Within the context of a quantum computing system, a requesting entity may request access to quantum computing resources, which may include qubits or services/processes implemented via qubits. Access granting entities generally will determine whether to grant access to quantum computing resources based on access policies. For example, a policy may dictate that access requesting entities assigned a specific role are to be provided access to a quantum computing resource. Based on this policy, the quantum access granting entity may provide access credentials to the requesting entity.

However, within distributed quantum computing environments, many entities can provide requests for the same resource within the same period of time, leading to multiple accesses of a resource and therefore decreasing the performance of the quantum computing environment. Furthermore, some entities may provide resource access requests in a format that is different than the requests of other entities, causing the quantum access granting entity to expend computational resources (e.g., power, memory, compute cycles, bandwidth, etc.) to parse and confirm the contents of a resource access request.

Accordingly, aspects of the present disclosure propose improved resource access request handling within quantum computing environments. In particular, a quantum computing system can obtain information from a quantum client device. The information can describe a request to access a quantum computing resource and an intended action associated with the quantum computing resource. Based on the information, the quantum computing system can send a quantum computing resource access request to a quantum access granting entity. The quantum computing resource access request can describe the requested quantum computing resource, the intended action (i.e., the action intended to be performed with the quantum computing resource), and an identity of the quantum client device.

The quantum computing system can also request that the quantum access granting entity assign a preliminary lock to the quantum computing resource. Responsive to sending the quantum resource access request, the quantum computing system can obtain information that indicates a decision by the quantum access granting entity to grant quantum computing resource access to the quantum client device. In such fashion, the quantum computing system can assign a preliminary lock to the requested quantum computing resource to assure that the quantum computing resource is not accessed by other entities while waiting for access to be granted by the quantum access granting entity, therefore substantially reducing the inefficiencies associated with unintended access of a quantum computing resource by multiple entities.

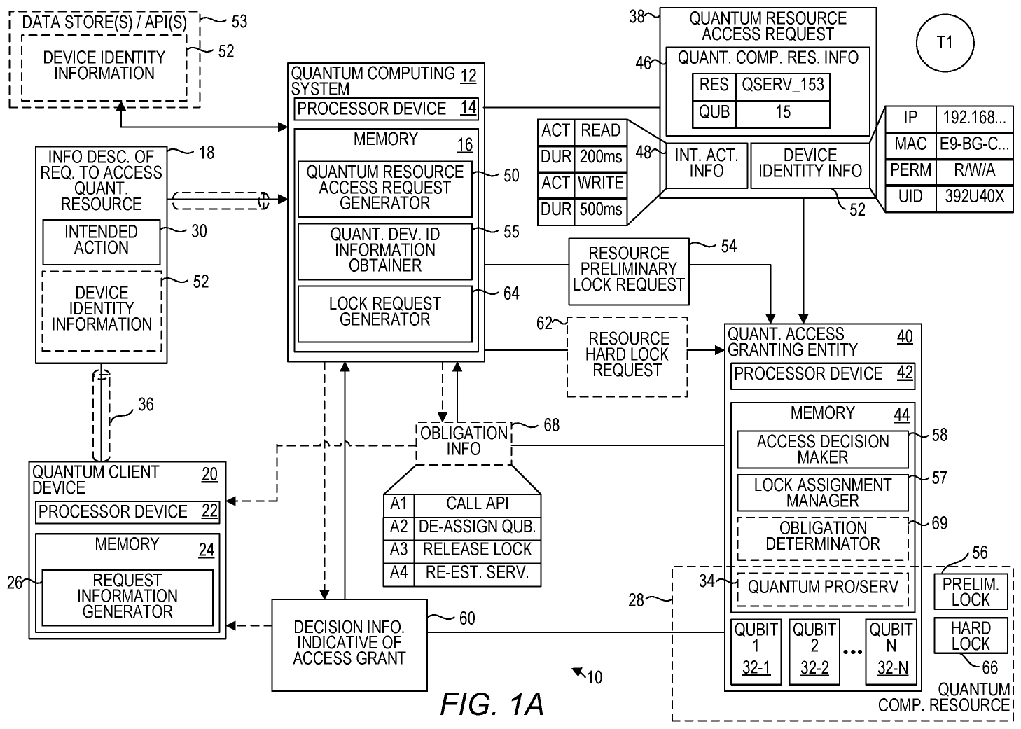

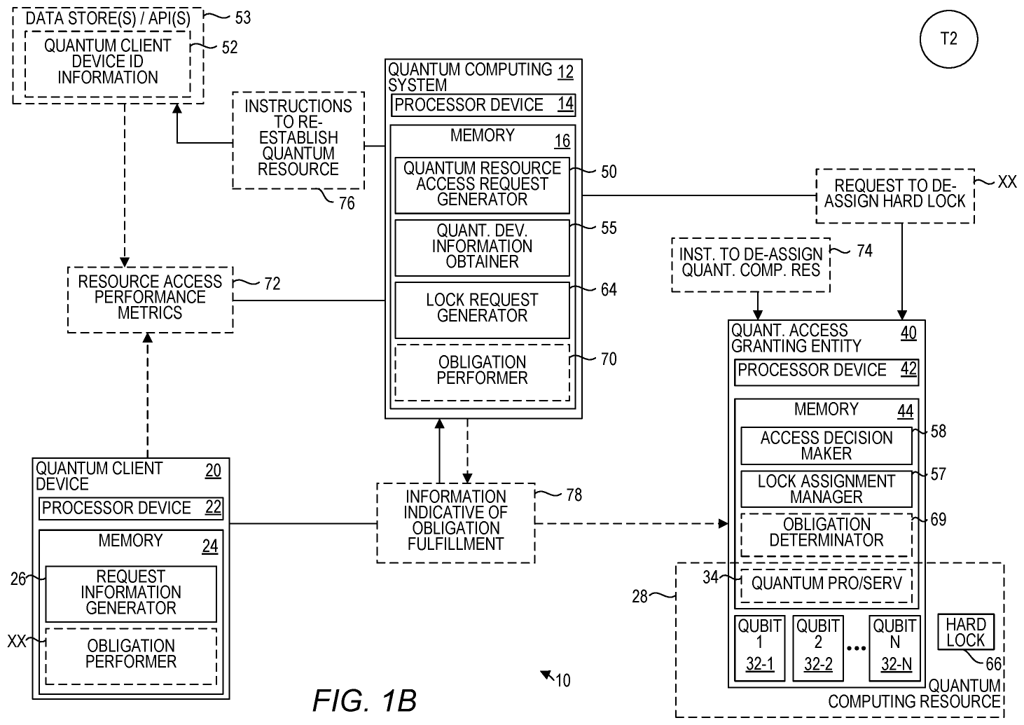

FIG. 1A is a block diagram of a quantum computing environment 10 at a period of time T1 in which examples may be practiced according to some implementations of the present disclosure. The quantum computing environment includes a quantum computing system 12 which operates in the quantum computing environment 10 but can operate using classical computing principles or quantum computing principles. When using quantum computing principles, the quantum computing system 12 performs computations that utilize quantum-mechanical phenomena, such as superposition and entanglement. The quantum computing system 12 may operate under certain environmental conditions, such as at or near 0° Kelvin. When using classical computing principles, the quantum computing system 12 utilizes binary digits that have a value of either 1 or 0.

The quantum computing system 12 includes at least one processor device 14 and at least one memory 16. The memory 16 can be or otherwise include any device(s) capable of storing data, including, but not limited to, volatile memory (random access memory, etc.), non-volatile memory, storage device(s) (e.g., hard drive(s), solid state drive(s), etc.).

In particular, at a period of time T1, the quantum computing system 12 can obtain information descriptive of a request 18 from a quantum client device 20. The quantum client device 20 can include a processor device 22 and a memory 24 as described with regards to quantum computing system 12. For example, the quantum client device 20 may generate the information descriptive of the request 18 using the request information generator 26. In particular, the quantum client device 20 may operate in the quantum computing environment 10 but can operate using classical computing principles or quantum computing principles. When using quantum computing principles, the quantum client device performs computations that utilize quantum-mechanical phenomena, such as superposition and entanglement. The quantum client device 20 may operate under certain environmental conditions, such as at or near 0° Kelvin. When using classical computing principles, the quantum client device 20 utilizes binary digits that have a value of either 1 or 0.

The information descriptive of the request 18 can describe a request to access a quantum computing resource 28, and an intended action 30 associated with the quantum computing resource 28. The quantum computing resource 28 can be any type or manner of quantum computing resource(s). For example, quantum computing resource 28 may include any number of qubits 32-1-32-M (generally, qubits 32). The number of qubits 32 could comprise hundreds or thousands of qubits 32. Additionally, or alternatively, the quantum computing resource 28 can include a quantum process/service 34 implemented using the qubits 32. As such, it should be broadly understood that the quantum computing resource 28 can include qubit(s), quantum process(es), quantum service(s), etc.

As described previously the quantum computing system 12 can obtain the information descriptive of the request 18 from the quantum client device 20. For example, the quantum computing system 12 may receive the information descriptive of the request 18 via a quantum communication channel 36. The information descriptive of the request 18 can describe an intended action 30 by the quantum client device 20 associated with the quantum computing resource 28. For example, if the quantum computing resource 28 is a set of the qubits 32, the intended action 30 may be a series of operations the quantum client device intends to perform using the set of the qubits 32. For another example, if the quantum computing resource 28 is a quantum process/service 34, the intended action 30 may be an intended application of the quantum process/service 34 by the quantum client device 20.

Based at least in part on the information descriptive of the request 18, the quantum computing system 12 can send a quantum computing resource access request 38 to a quantum access granting entity 40. The quantum access granting entity 40 can include a processor device 42 and memory 44, and can perform operations as described previously with regards to quantum computing system 12. Importantly, it should be noted that, although the implementation illustrated in FIG. 1A depicts the quantum computing resource 28 (e.g., qubits 32 and quantum process/service 34) as being implemented by the quantum access granting entity 40, this is not necessarily the case in other implementations of the present disclosure. Rather, in other implementations, the quantum computing resource 28 may be at least partially implemented or otherwise provided by other entities within the quantum computing environment (not illustrated). For example, at least some of the qubits 32 may be located on a quantum computing device other than the quantum access granting entity 40. For another example, the quantum process/service 34 may be implemented by another quantum computing device, while the qubits 32 are implemented by the quantum access granting entity 40. As such, it should be broadly understood that the quantum computing resource 28 can be implemented or otherwise provided by any number of quantum computing devices that may or may not include the quantum access granting entity 40.

More particularly, the quantum computing resource access request 38 can include quantum computing resource information 46 that describes the quantum computing resource 28. For example, if the quantum computing resource 28 is a quantum process/service 34, the quantum computing resource information 46 may describe a quantum process ID or service ID for the quantum process/service 34. For another example, if the quantum computing resource 28 is a set of qubits, the quantum computing resource information 46 may describe a requested type of qubits (e.g., charge qubit, flux qubit, etc.), quantity of qubits, location of qubits, quantum qubit material (e.g., superconducting material, trapped-ion material, gapped topological material, etc.).

Additionally, the quantum computing resource access request 38 can include intended action information 48 descriptive of the intended action 30. For example, if the intended action 30 is a series of operations (e.g., READ, WRITE, etc.), the intended action information 48 may describe each operation and a predicted duration of the operation. For another example, if the intended action is to call a quantum process/service 34, the intended action information 48 may describe intended inputs/outputs associated with the quantum process/service 34, a predicted duration for which the quantum process/service 34 will be utilized, etc. In some implementations, the intended action information 48 may be provided to the quantum computing system 12 in the information descriptive of the request 18 to access the quantum computing resource 28. Alternatively, in some implementations, the quantum computing system 12 may determine or generate the intended action information 48 (e.g., using the quantum resource access request generator 50, etc.).

Additionally, the quantum computing resource access request 38 can include device identity information 52 that describes an identity of the quantum client device 20. For example, the device identity information 52 may describe an IP address, AMC address, etc. associated with the quantum client device 20. For another example, the device identity information 52 may describe an identity of a user associated with the quantum client device 20 (e.g., a user ID, etc.). For another example, the device identity information 52 may describe roles and/or permissions assigned to the quantum client device 20 (e.g., a role within the quantum computing environment 10, permissions assigned to the quantum client device 20 by an administrating device, etc.). For yet another example, the device identity information 52 may describe technical capabilities of the quantum client device 20 (e.g., an available quantity of storage, performance metrics, etc.).

In some implementations, the device identity information 52 may be included in the information descriptive of the request 18 provided by the quantum client device 20. Alternatively, in some implementations, the quantum computing system 12 can access one or more data store(s)/API(s) 53 (Application Programming Interfaces) (e.g., using quantum client device identity information obtainer 55, etc.). For example, the data store(s)/API(s) 53 may be a data repository that stores information regarding the technical specifications of the quantum client device 20. For another example, the data store(s)/API(s) 53 may be a network API that relays network information such as an IP address of the quantum client device 20, etc.

The quantum computing system 12 can provide the quantum resource access request 38 to the quantum access granting entity 40. Additionally, while the quantum access granting entity 40 decides whether to grant the quantum client device 20 access to the quantum computing resource 28 based on the quantum computing resource access request 38, the quantum computing system 12 can provide a resource preliminary lock request 54 to assign a preliminary lock 56 to the quantum access granting entity 28. The resource preliminary lock request 54 to assign a preliminary lock 56 can request that the quantum access granting entity 40 assign a preliminary lock 56 to the quantum computing resource 28 until a decision has been made regarding access to the quantum computing resource 28.

The quantum access granting entity 40 can process the quantum computing resource access request 38 (e.g., with access decision maker 58, etc.) to make a decision whether to grant the quantum client device 20 access to the quantum computing resource 28. While making a decision, the quantum access granting entity 40 can assign the preliminary lock 56 to the quantum computing resource 28 responsive to the resource preliminary lock request 54 to assign a preliminary lock 56 (e.g., using lock assignment manager 57, etc.). The preliminary lock 56 can block access to the quantum computing resource 28 by other entities temporarily. In some implementations, the preliminary lock 56 may be a “soft lock” that can be overridden by an entity that has been granted sufficient permissions to do so.

In response to sending the quantum computing resource access request 38 to the quantum access granting entity 40, the quantum computing system 12 can receive decision information 60 indicative of a decision to grant quantum computing resource access to the quantum client device 20. In some implementations, the quantum computing system 12 can then forward the decision information 60 to the quantum client device 20. Alternatively, in some implementations, the quantum access granting entity 40 may directly provide the decision information 60 to the quantum client device 20. In some implementations, the decision information 60 may also include data that provides access to the quantum computing resource 28 (e.g., a hash value, access credentials, a password, an encoding, etc.).

In some implementations, the quantum computing system 12, in response to receiving the decision information 60, can provide a resource hard lock request 62 (e.g., using the lock request generator 64, etc.). In response, the quantum access granting entity 40 can assign a hard lock 66 to the quantum computing resource 28. The hard lock 66 is to block access to the quantum computing resource 28 by all other entities until the quantum client device 20 has released the quantum computing resource 28, or until the access granted to the quantum client device 20 expires.

In some implementations, the quantum access granting entity 40 can generate obligation information 68 (e.g., using the obligation determinator 69, etc.). The quantum computing system 12 can obtain the obligation information 68 from the quantum access granting entity 40. The obligation information 68 can describe an obligation that is fulfillable by either the quantum computing system 12 or the quantum client device 20. The obligation can include one or more actions associated with the quantum computing resource 28. In some implementations, the quantum computing system 12 can forward the obligation information 68 to the quantum client device 20. Alternatively, in some implementations, the quantum access granting entity 40 can provide the obligation information 68 directly to the quantum client device 20.

The action(s) described by the obligation information 68 can be actions associated with the quantum computing resource 28. For example, if the quantum computing resource 28 is, or otherwise includes, a set of the qubits 32, the obligation information 68 may describe an action in which the quantum client device 20, or the quantum computing system 12, reports performance metrics associated with the qubits so that the quantum access granting entity 40 can make more accurate access grant decisions in the future (e.g., a temperature of the qubits, a degree of decoherence, an error rate, etc.). For another example, if the quantum computing resource 28 is, or otherwise includes, the quantum process/service 34, the obligation information 68 may describe a series of actions in which the quantum client device 20, or the quantum computing system 12, re-establishes the quantum process/service 34 for successive re-assignment to another requesting entity by the quantum access granting entity 40. As a specific example, these actions may include calling an API (e.g., data store(s)/API(s) 53, etc.) to indicate that use of the quantum computing resource 28 is over; providing instructions to de-assign the quantum computing resource 28 from the quantum client device 20; release lock(s) (e.g., hard lock 66, etc.) assigned to the quantum computing resource 28; and re-establish the quantum process/service 34 (e.g., if the service is in an intermediary state then restart the service, etc.).

It should be noted that the obligation described by the obligation information 68 is not required to be fulfilled by the quantum computing system 12 or the quantum client device 20. Rather, either may instead determine to not fulfill the obligation entirely, or may determine to partially fulfill the obligation.

Furthermore, it should be noted that, as described previously, the quantum computing resource 28 may be implemented by or otherwise located on quantum computing entities other than the quantum access granting entity 40. As such, although the resource preliminary lock request 54 and the resource hard lock request 62 are depicted in FIG. 1A as being provided to the quantum access granting entity 40, they may instead be provided to whatever quantum computing entity implements the quantum computing resource 28.

FIG. 1B is a block diagram of a quantum computing environment 10 at a second period of time T2 in which examples may be practiced according to some implementations of the present disclosure. In particular, at time T2, the obligation information 68 of FIG. 1A has been provided by the quantum access granting entity 40 to the quantum computing system 12 and/or the quantum client device 20. In some implementations, the obligation information 68 has been provided to the quantum computing system 12. In response, the quantum computing system can fulfill the obligation by performing the one or more actions described by the obligation information 68 (e.g., using obligation action performer 70, etc.).

For example, the obligation may describe an action in which the quantum computing system 12 obtains performance metrics associated with access of the quantum computing resource 28 by the quantum client device 20. In response, the quantum computing system 12 can obtain resource access performance metrics 72 from the quantum client device 20 or from data store(s)/API(s) 53 (e.g., an API/data store for a service/device that monitors the performance of the quantum computing resource 28, etc.).

For another example, the obligation may describe an action in which the quantum computing system 12 provides instructions to the quantum access granting entity 40 to release any policies associated with the decision to grant the quantum computing resource access to the quantum client device 20. In response, the quantum computing system 12 can generate and provide instructions 74 to de-assign the quantum computing resource 28 from the quantum client device 20, or to otherwise revoke the access provided to the quantum client device 20.

For another example, the obligation may describe an action in which the quantum computing system 12 provides instructions to re-establish the quantum computing resource 28 for subsequent access of the quantum computing resource 28. In response, the quantum computing system 12 can provide re-establishment instructions 76 to re-establish the quantum computing resource 28 via the data store(s)/API(s) 53 so that the quantum computing resource 28 is re-established for subsequent access.

It should be noted that, in some implementations, the quantum client device 20 may perform some, or all, of the above-described actions to fulfill the obligation described by the obligation information 68 of FIG. 1A. In some implementations, if the quantum client device 20 fulfills at least a portion of the obligation, the quantum computing system 12 can obtain information indicative of fulfillment of the obligation 78. In response to receiving the information indicative of fulfillment of the obligation, the quantum computing system 12 can provide a request for hard lock de-assignment 80. The request for hard lock de-assignment 80 can request that the quantum access granting entity 40 de-assign the hard lock 66 from the quantum computing resource 28. In such fashion, fulfillment of the obligation described by the obligation information 68 of FIG. 1A can ensure the smooth transition of the quantum computing resource 28 for subsequent re-assignment to another quantum computing entity.

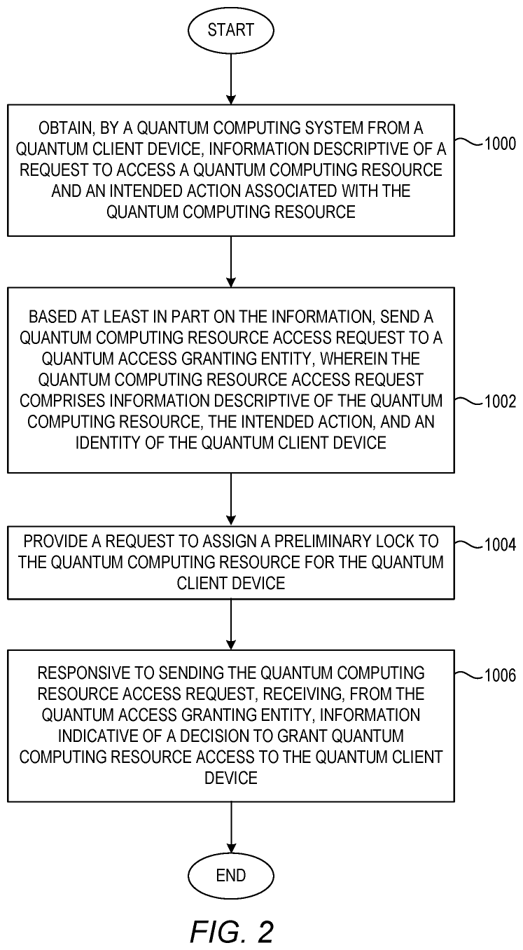

FIG. 2 is a flowchart of a method for access request handling for access to quantum computing resources according to some implementations of the present disclosure. FIG. 2 will be discussed in conjunction with FIG. 1. The quantum computing system 12 obtains, from a quantum client device 20, information descriptive of a request 18 to access a quantum computing resource 28 and an intended action 30 associated with the quantum computing resource 28 (FIG. 2, block 1000). The quantum computing system 12, based at least in part on the information descriptive of the request 18, sends a quantum computing resource access request 38 to the quantum access granting entity 40 (FIG. 2, block 1002). The quantum computing resource access request 38 includes information descriptive of the quantum computing resource 28 (e.g., quantum computing resource information 46), information descriptive of the intended action 30 (e.g., intended action information 48), and information descriptive of an identity of the quantum client device 20 (e.g., device identity information 52). The quantum computing system 12 provides a request to assign a preliminary lock 56 (e.g., resource preliminary lock request 54) to the quantum computing resource 28 for the quantum client device 20 (FIG. 2, block 1004). The quantum computing system 12, responsive to sending the quantum computing resource access request 38, receives, from the quantum access granting entity 40, decision information 60 indicative of a decision to grant quantum computing resource 28 access to the quantum client device 20 (FIG. 2, block 1006).

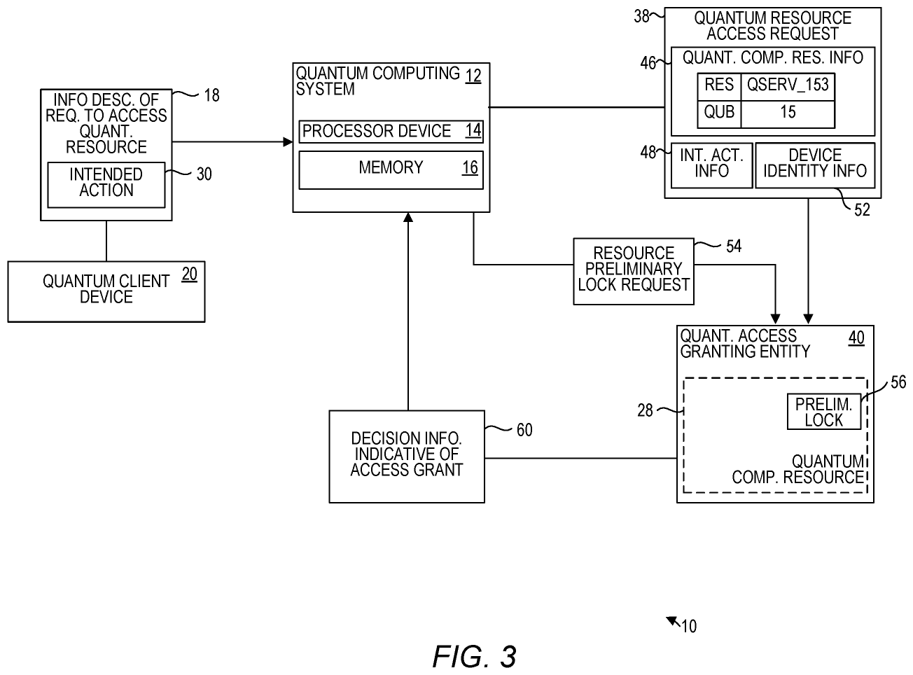

FIG. 3 is a simplified block diagram of the quantum computing environment 10 illustrated in FIG. 1 according to some implementations of the present disclosure. The quantum computing environment 10 includes the quantum computing system 12 which in turn includes the memory 16 and the processor device 14 coupled to the memory 16. The processor device 14 is to obtain, from the quantum client device 20, information descriptive of a request 18 to access a quantum computing resource 28 and an intended action 30 associated with the quantum computing resource 28. The processor device 14 is to, based at least in part on the information descriptive of the request 18, send the quantum computing resource access request 38 to the quantum access granting entity 40. The quantum computing resource access request 38 includes quantum computing resource information 46 descriptive of the quantum computing resource 28. The quantum computing resource access request 38 includes intended action information 48 descriptive of the intended action 30. The quantum computing resource access request 38 includes device identity information 52 descriptive of the identity of the quantum client device 20. The processor device 14 is to provide the resource preliminary lock request 54 to assign a preliminary lock 56 to the quantum computing resource 28 for the quantum client device 20. The processor device 14 is to, responsive to sending the quantum computing resource access request 38, receiving, from the quantum access granting entity 40, decision information 60 indicative of a decision to grant quantum computing resource 28 access to the quantum client device 20.

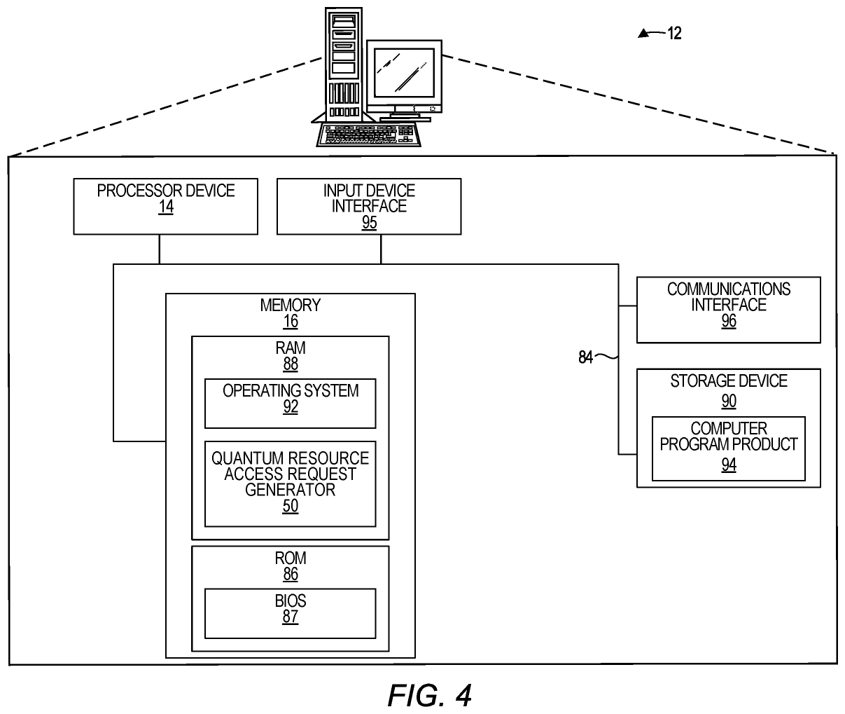

FIG. 4 is a block diagram of the quantum computing system 12 suitable for implementing examples according to some implementations of the present disclosure. The quantum computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The quantum computing system 12 includes the processor device 14, the system memory 16, and a system bus 84. The system bus 84 provides an interface for system components including, but not limited to, the system memory 16 and the processor device 14. The processor device 14 can be any commercially available or proprietary processor.

The system bus 84 may be any of several types of bus structures that may further interconnect to a memory bus (with or without a memory controller), a peripheral bus, and/or a local bus using any of a variety of commercially available bus architectures. The system memory 16 may include non-volatile memory 86 (e.g., read-only memory (ROM), erasable programmable read-only memory (EPROM), electrically erasable programmable read-only memory (EEPROM), etc.), and volatile memory 88 (e.g., random-access memory (RAM)). A basic input/output system (BIOS) 87 may be stored in the non-volatile memory 86 and can include the basic routines that help to transfer information between elements within the quantum computing system 12. The volatile memory 88 may also include a high-speed RAM, such as static RAM, for caching data.

The quantum computing system 12 may further include or be coupled to a non-transitory computer-readable storage medium such as the storage device 90, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 90 and other drives associated with computer-readable media and computer-usable media may provide non-volatile storage of data, data structures, computer-executable instructions, and the like.

A number of modules can be stored in the storage device 90 and in the volatile memory 88, including an operating system 92 and one or more program modules, such as the quantum resource access request generator 50, which may implement the functionality described herein in whole or in part. All or a portion of the examples may be implemented as a computer program product 94 stored on a transitory or non-transitory computer-usable or computer-readable storage medium, such as the storage device 90, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the quantum resource access request generator 50 in the volatile memory 88, may serve as a controller, or control system, for the quantum computing system 12 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 14 through an input device interface 95 that is coupled to the system bus 84 but can be connected by other interfaces such as a parallel port, an Institute of Electrical and Electronic Engineers (IEEE) 1394 serial port, a Universal Serial Bus (USB) port, an IR interface, and the like. The quantum computing system 12 may also include the communications interface 96 suitable for communicating with the network as appropriate or desired. The quantum computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a quantum computing system from a quantum client device, information descriptive of a request to access a quantum computing resource and an intended action associated with the quantum computing resource;
based at least in part on the information, sending a quantum computing resource access request to a quantum access granting entity, wherein the quantum computing resource access request comprises information descriptive of:
the quantum computing resource;
the intended action; and
an identity of the quantum client device;
providing a request to assign a preliminary lock to the quantum computing resource for the quantum client device; and
responsive to sending the quantum computing resource access request, receiving, from the quantum access granting entity, information indicative of a decision to grant quantum computing resource access to the quantum client device.

2. The method of claim 1, wherein the method further comprises sending information to the quantum client device indicative of the decision to grant quantum computing resource access to the quantum client device.

3. The method of claim 1, wherein the method further comprises, responsive to receiving the information indicative of the decision to grant quantum computing resource access, providing a request to assign a hard lock to the quantum computing resource for the quantum client device, wherein the hard lock is to block access to the quantum computing resource by entities other than the quantum client device.

4. The method of claim 3, wherein receiving the information indicative of the decision to grant quantum computing resource access to the quantum client device further comprises:
receiving information descriptive of an obligation that is fulfillable by either the quantum computing system or the quantum client device, wherein the obligation comprises one or more actions associated with the quantum computing resource.

5. The method of claim 4, wherein the method further comprises sending the information descriptive of the obligation to the quantum client device.

6. The method of claim 5, wherein the method further comprises receiving, from the quantum client device, information indicative of fulfillment of the obligation.

7. The method of claim 6, wherein the method further comprises providing a request to de-assign the hard lock from the quantum computing resource for the quantum client device.

8. The method of claim 4, wherein the method further comprises performing the one or more actions associated with the quantum computing resource.

9. The method of claim 8, wherein performing the one or more actions associated with the quantum computing resource comprises providing, to the quantum access granting entity, instructions to release any policies associated with the decision to grant quantum computing resource access to the quantum client device.

10. The method of claim 8, wherein performing the one or more actions associated with the quantum computing resource comprises:
obtaining performance metrics associated with access of the quantum computing resource by the quantum client device; and
providing the performance metrics to the quantum client device.

11. The method of claim 8, wherein performing the one or more actions associated with the quantum computing resource comprises:
providing, via an application programming interface (API) associated with the quantum computing resource, instructions to re-establish the quantum computing resource for subsequent access of the quantum computing resource.

12. The method of claim 1, wherein obtaining the request for access comprises obtaining, from the quantum client device via a quantum communication channel, the request for access to the quantum computing resource.

13. A quantum computing system, comprising:
a memory; and
a processor device coupled to the memory to:
obtain, from a quantum client device, information descriptive of a request to access a quantum computing resource and an intended action associated with the quantum computing resource;
based at least in part on the information, send a quantum computing resource access request to a quantum access granting entity, wherein the quantum computing resource access request comprises information descriptive of:
the quantum computing resource;
the intended action; and
an identity of the quantum client device;
provide a request to assign a preliminary lock to the quantum computing resource for the quantum client device; and
responsive to sending the quantum computing resource access request, receive, from the quantum access granting entity, information indicative of a decision to grant quantum computing resource access to the quantum client device.

14. The quantum computing system of claim 13, wherein the processor device is further coupled to the memory to send information to the quantum client device indicative of the decision to grant quantum computing resource access to the quantum client device.

15. The quantum computing system of claim 13, wherein the processor device is further coupled to the memory to, responsive to receiving the information indicative of the decision to grant quantum computing resource access, provide a request to assign a hard lock to the quantum computing resource for the quantum client device, wherein the hard lock is to block access to the quantum computing resource by entities other than the quantum client device.

16. The quantum computing system of claim 15, receiving the information indicative of the decision to grant quantum computing resource access to the quantum client device further comprises:
receiving information descriptive of an obligation that is fulfillable by either the quantum computing system or the quantum client device, wherein the obligation comprises one or more actions associated with the quantum computing resource.

17. The quantum computing system of claim 16, wherein the processor device is further coupled to the memory to send the information descriptive of the obligation to the quantum client device.

18. The quantum computing system of claim 17, wherein the processor device is further coupled to the memory to receive, from the quantum client device, information indicative of fulfillment of the obligation.

19. The quantum computing system of claim 18, wherein the processor device is further coupled to the memory to provide a request to de-assign the hard lock from the quantum computing resource for the quantum client device.

20. A non-transitory computer-readable storage medium that includes executable instructions to cause a processor device of a quantum computing system to:
obtain, from a quantum client device, information descriptive of a request to access a quantum computing resource and an intended action associated with the quantum computing resource;
based at least in part on the information, send a quantum computing resource access request to a quantum access granting entity, wherein the quantum computing resource access request comprises information descriptive of:
the quantum computing resource;
the intended action; and
an identity of the quantum client device;
provide a request to assign a preliminary lock to the quantum computing resource for the quantum client device; and
responsive to sending the quantum computing resource access request, receive, from the quantum access granting entity, information indicative of a decision to grant quantum computing resource access to the quantum client device.
